(19) United States
(12) Patent Application Publication
(10) Pub. No.: US 2009/0003582 A1
(43) Pub. Date: Jan. 1, 2009

(54) Optimized Replacement of Calls Using A Grid Parameter

(75) Inventors: Li Shen, Bellevue, WA (US); Danny Levin, Redmond, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/769,631

(22) Filed: Jun. 27, 2007

(51) Int. Cl. H04M 7/00

(52) U.S. Cl. 379/220.01

(57) ABSTRACT

Tools and techniques for optimized replacement of calls using a grid parameter are described herein. The tools may provide machine-readable storage media containing machine-readable instructions for receiving indications of incoming calls, and for populating fields in a contact header structure that are associated with the incoming call. The fields may include a field for containing a globally unique identifier (GUID) associated with the incoming call. The tools may also receive requests to replace a call within a plurality of active calls that are handled by a server. In response to such requests, the tools may search for the call using the GUID.

### BACKGROUND

Voice and data communications are increasingly being managed using digital, packet-switched, systems, rather than analog, circuit-switched systems. Examples of such digital systems may include server-based systems that enable a variety of different callers to communicate with one another, perhaps using dissimilar devices, signaling protocols, and/or transmission techniques. Put differently, the servers may host and manage any number of different calls at any given time.

As these servers manage more calls, and different types of calls, some operations may involve locating a given call out of many active calls that the server is currently handling. While it is possible to perform a linear search on a list of these active calls, this type of a brute-force approach may prove expensive in the context of servers handling, for example, hundreds or thousands of calls or callers.

### SUMMARY

Tools and techniques for optimized replacement of calls using a grid parameter are described herein. The tools may provide machine-readable storage media containing machine-readable instructions for receiving indications of incoming calls, and for populating fields in a contact header structure that are associated with the incoming call. The fields may include a field for containing a globally unique identifier (GUID) associated with the incoming call. The tools may also receive requests to replace a call within a plurality of active calls that are handled by a server. In response to such requests, the tools may search for the call using the GUID.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTIONS OF THE DRAWINGS

Tools related to optimized replacement of calls using a grid parameter are described in connection with the following drawing figures. The same numbers are used throughout the disclosure and figures to reference like components and features. The first digit in a reference number indicates the drawing figure in which that reference number is introduced.

FIG. 1 is a block diagram illustrating systems and/or operating environments in which tools and techniques for optimized replacement of calls using a grid parameter may perform.

FIG. 2 is a block diagram illustrating additional details relating to a grid creation and maintenance module provided as part of the tools.

FIG. 3 is a block diagram illustrating processes for building a contact header and dictionary structures as incoming calls arrive.

FIG. 4 is a block diagram illustrating processes for replacing one or more of the calls using the contact header and dictionary structures.

### DETAILED DESCRIPTION

### Overview

The following document describes tools capable of performing and/or supporting many techniques and processes. The following discussion describes exemplary ways in which the tools provide for optimized replacement of calls using a grid parameter. Without limiting possible implementations, and only to facilitate understanding of the description herein, the term “grid” as used herein refers to a value field within a globally routable user agent uniform resource identifier (URI) (GRUU). The GRUU parameter is part of a contact header used to pass information between endpoints as part of, for example, establishing and maintaining communication sessions under the Session Initiation Protocol (SIP). Similarly, the term “replace” is used herein to refer to replacing one participant with another in a multimedia conversion in an atomic operation. This discussion also describes other techniques and/or processes that the tools may perform.

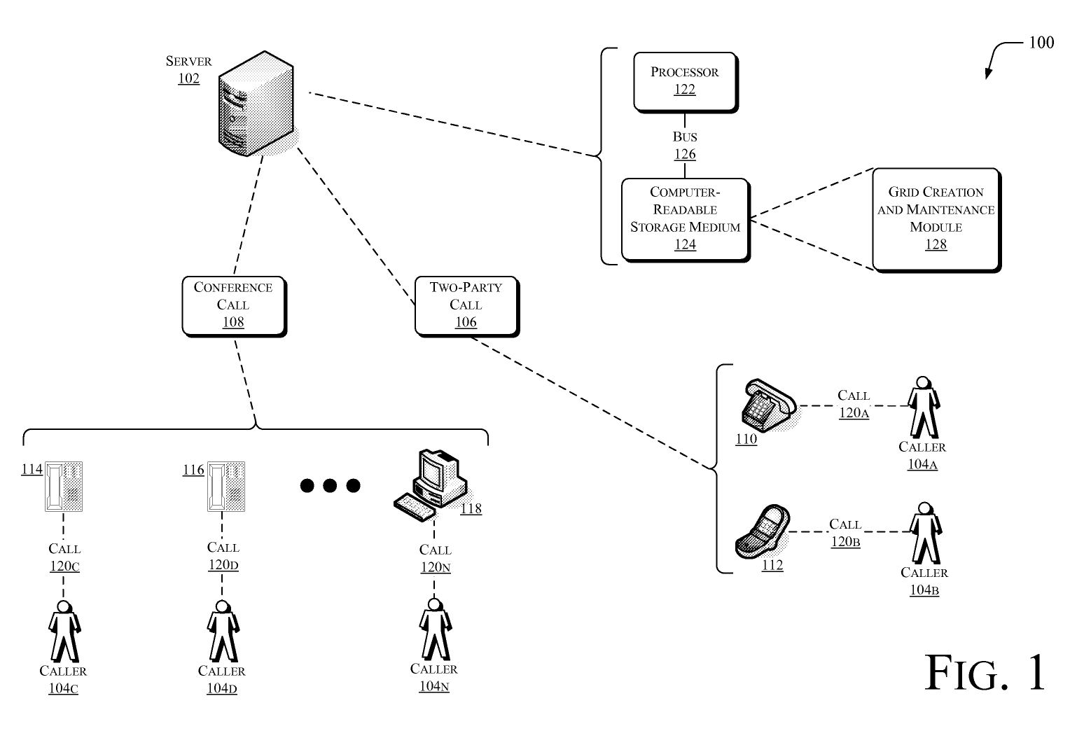

FIG. 1 illustrates systems and/or operating environments 100 in which tools and techniques for optimized replacement of calls using a grid parameter may perform. The systems 100 may include one or more servers 102. However, it is noted that this description provides this example device only to facilitate discussion of the subject matter herein, but not to limit possible implementations of this subject matter. The server 102 may perform as an audio-video multimedia control unit (AVMCU), as a media server, or the like.

The server 102 may enable callers to place calls to one another, thereby connecting the callers with one another so as to enable them to exchange audio, video, data communications (whether alone or in combination) therebetween. FIG. 1 provides examples in which two callers 104a and 104b are engaged in a two-party call, denoted generally at 106. Also, three or more callers 104c, 104d, and 104n are shown engaged in a conference call, denoted generally at 108.

FIG. 1 also provides examples of various devices that the callers may use to contact one another. For example, the caller 104a may use a desktop telephone 110 to contact the caller 104b, while the caller 104b may communicate using a wireless device 112. The callers 104a and 104b may exchange voice traffic, data, instant messages (IMs), text messages, or the like. One or more of the callers may communicate through intermediate public switched telephone networks (PSTNs).

Turning to the callers 104c, 104d, and 104n, these callers may communicate using telephones 114 and 116, as well as desktop computing system 118. The server 102 may enable the telephones 114 and 116 and the desktop computing system 118 to communicate with one another over voice over IP (VoIP) technologies.

FIG. 1 denotes the various calls linking the callers respectively at 120a, 120b, 120c, 120d, and 120n (collectively, calls 120). The calls 120 are shown as dashed lines to represent the structures and records associated with implementing the various calls.

Turning to the server 102 in more detail, the server may be a computer-based system that includes one or more processors, denoted at 122. These processors may also be categorized or characterized as having a given type or architecture, but in implementations that include more than one processor, these processors may or may not have the same type or architecture.

The device may also include one or more instances of machine-readable or computer-readable storage media, denoted generally at 124. The processor may communicate with the computer-readable media, and other components or sub-systems of the devices, via one or more busses 126. These busses 126 may be of any suitable width, and may comply with any convenient bus architecture.

The computer-readable media 124 may contain instructions that, when executed by the processor 122, perform any of the tools or related functions that are described herein as being performed by the server. The processor may access and/or execute the instructions embedded or encoded onto the computer-readable media, and/or may access data stored in the computer-readable media. Additionally, it is noted that the computer-readable storage media, and any software stored thereon, may reside on hardware other than that shown in FIG. 1 without departing from the scope and spirit of the description herein. The examples shown in FIG. 1 are provided only to facilitate discussion, but not to limit possible implementations.

Turning in more detail to the computer-readable media 124, it may include one or more modules of software instructions for optimizing replacement of calls using a grid parameter, denoted generally as a grid creation and maintenance module 128. As a non-limiting example of optimized replacement of calls using a grid parameter, one or more of the callers 104a or 104b may wish to join an ongoing conference (e.g., 108). Assuming that the server 102 operates under the Session Initiation Protocol (SIP), the server may issue a SIP Invite with Replace command to replace the call as connected to the two-party call 106 with a call connected to the conference call 108. For example, if the caller 104a wishes to join an ongoing conference call 108, then the call 120a would be replaced with a corresponding call linking the caller 104a to the conference call.

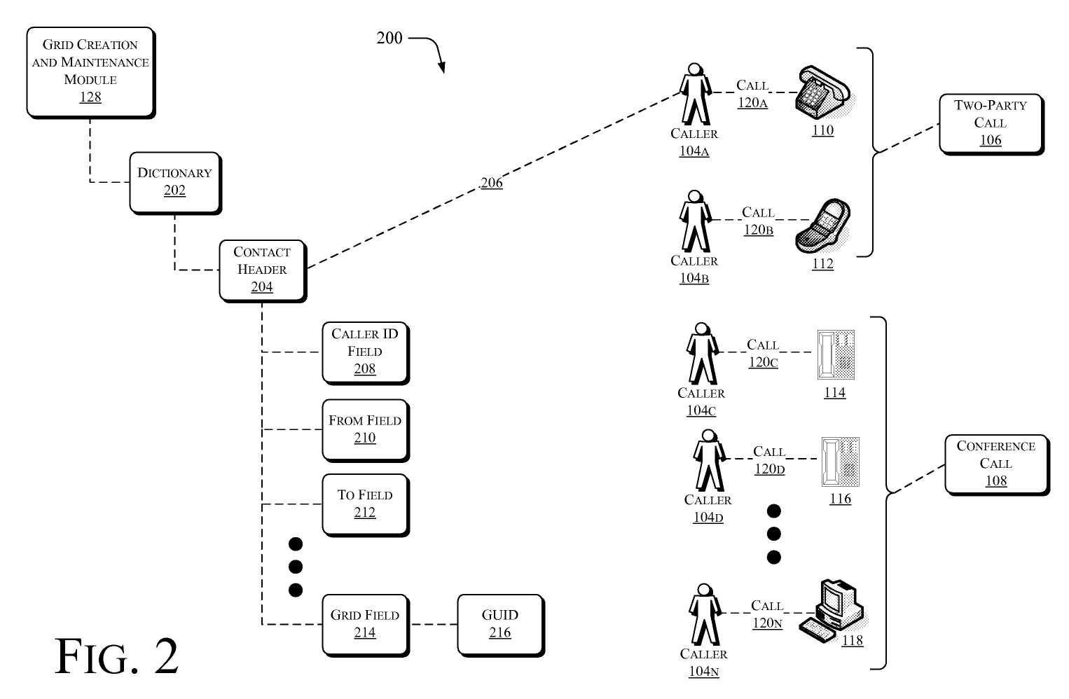

FIG. 2 illustrates additional details relating to the grid creation and maintenance module 128. For convenience of description, but not to limit possible implementations, FIG. 2 may carry forward some items described previously, and may denote them by similar reference signs.

The grid creation and maintenance module 128 may manage a dictionary 202, which in turn may include a contact header structure 204 corresponding to a call 120. In the interests of clarity, FIG. 2 shows one contact header structure 204, associated with the call 102a as indicated by the dashed line 206. However, it is noted that the module 128 may maintain a respective contact header structure for the various calls 120.

Turning to the contact header 204 in more detail, it may include a call identifier (ID) field or tag 208. Typically, the call ID is a relatively lengthy alphanumeric string, generated based on an address or URL, combined with randomly-generated strings of digits and/or characters. The contact header may also include a “from” field or tag 210, which indicates which caller initiated or originated a given call. A “to” field 212 may indicate which caller received a given call. A grid field 214 may contain a globally unique identifier (GUID), as represented generally at 216, that is associated with a given call 120. In some implementations, a server (e.g., 102) may generate the GUID, while in other implementations, the call request or invitation incoming to the server may include the GUID, with other devices (e.g., 110-118) generating the GUID and including it in the invitation.

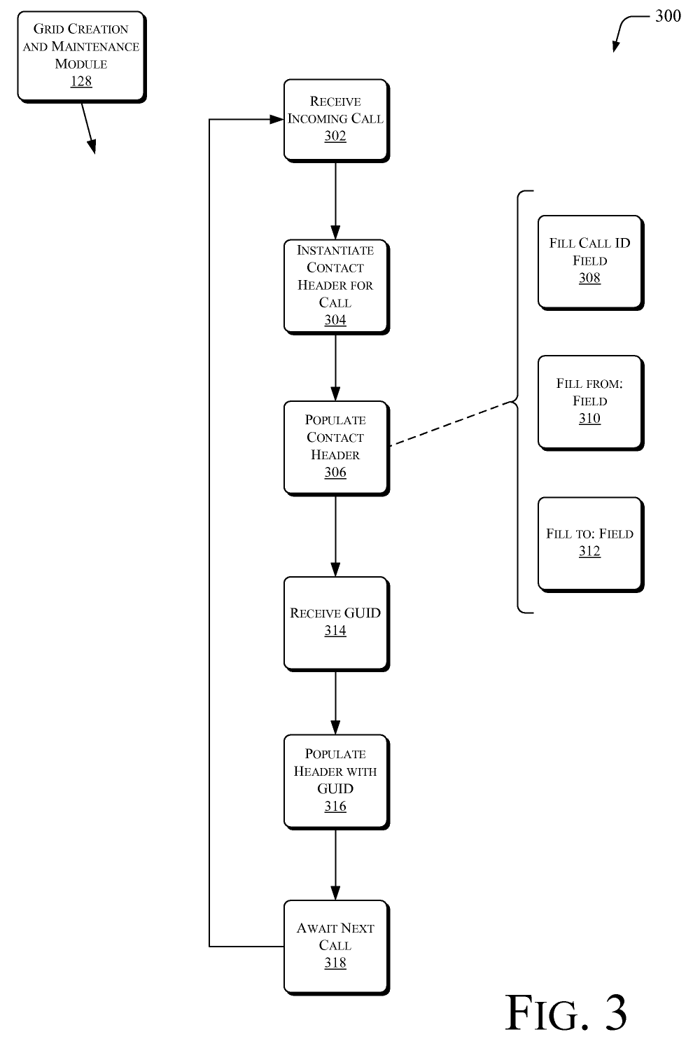

As detailed further in FIG. 3, the module 128 may build new contact header structures as calls come in. Additionally, the module 128 may modify these header structures as calls are replaced, and may delete these structures when calls terminate.

FIG. 3 illustrates process flows 300 for building the contact header and dictionary structures as incoming calls arrive. For convenience of description, but not to limit possible implementations, FIG. 3 may carry forward some items described previously, and may denote them by similar reference signs. Also, FIG. 3 illustrates scenarios in which the grid creation and maintenance module 128 performs the process flows 300, but it is noted that other systems or components may perform some or all of these process flows without departing from the scope and spirit of the description herein.

Block 302 represents receiving an indication of a given incoming call request. FIGS. 1 and 2 provide examples of calls at 120.

Block 304 represents instantiating a contact header structure for the incoming call, if such a structure has not already been instantiated. FIG. 2 provides examples of contact header structures at 204.

Block 306 represents populating or filling the various fields or tags defined by the contact header structure. For example, block 306 may include populating a call ID field (e.g., 208 in FIG. 2), as denoted at block 308. Block 306 may include populating a “from” field (e.g., 210 in FIG. 2), as denoted at block 310, and may include populating a “to” field (e.g., 212 in FIG. 2), as denoted at block 312.

Block 314 represents receiving a GUID for the contact header associated with the incoming call. FIG. 2 provides examples of the GUID at 216.

Block 316 represents populating the contact header with the GUID. FIG. 2 provides an example of a grid field 214 that may contain the GUID 216. Finally, block 318 represents a wait state in which the process flows 300 may await the arrival of a next incoming call request.

Assuming that the process flows 300 are implemented in a SIP environment, the foregoing process blocks 302-318 may be implemented using appropriate SIP commands.

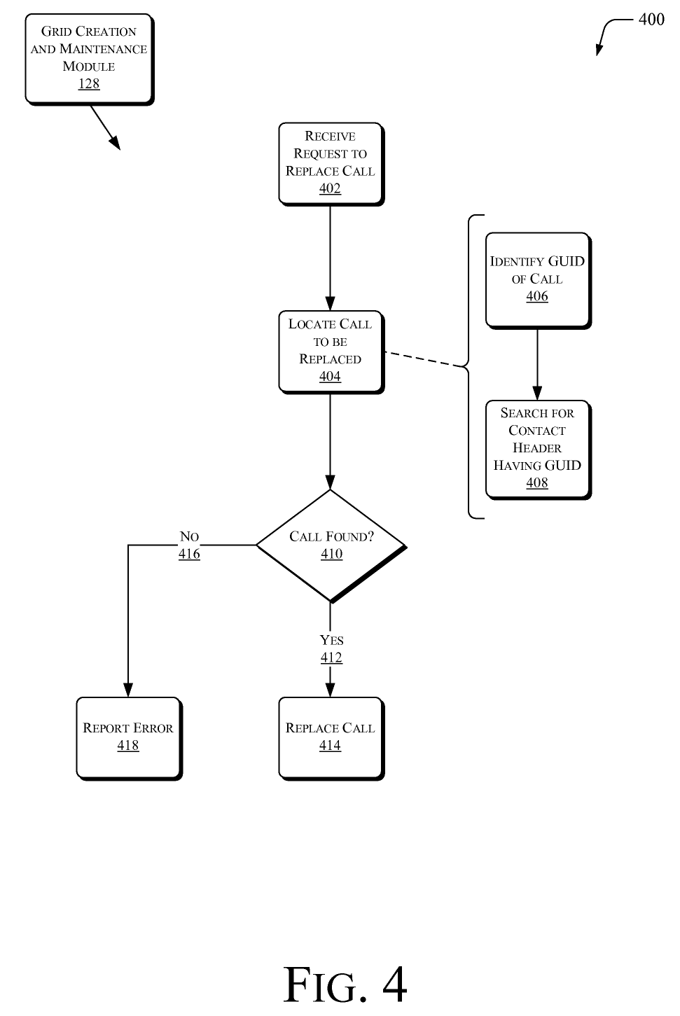

Having described the process flows 300 for building the contact header and dictionary structures as incoming calls arrive, the discussion now turns to a description of process flows that the tools may perform upon a request to replace a given one of the calls, now presented with FIG. 4.

FIG. 4 illustrates process flows 400 for replacing one or more of the calls. For convenience of description, but not to limit possible implementations, FIG. 4 may carry forward some items described previously, and may denote them by similar reference signs. Also, FIG. 4 illustrates scenarios in which the grid creation and maintenance module 128 performs the process flows 400, but it is noted that other systems or components may perform some or all of these process flows without departing from the scope and spirit of the description herein.

Block 402 represents receiving a request to replace a given call (e.g., 120 in FIGS. 1 and 2). For example, a number of callers may be participating in a two-party call (e.g., 106 as shown in FIGS. 1 or 2). At some convenient point, one or more of these callers may wish to join a conference (e.g., 108 shown in FIGS. 1 or 2). This conference may be a currently ongoing conference, or the conference may be created for these callers. Assuming a SIP implementation, block 402 may include, for example, receiving a SIP-compliant invite-with-replace command.

Block 404 represents locating the call to be replaced from among all active calls currently being handled. As shown in FIG. 4, block 404 may include identifying a GUID associated with the call to be replaced, as denoted in block 406. Block 408 represents querying for the contact header associated with the GUID identified in block 406.

Block 410 represents evaluating whether a call was found for the GUID. If yes, the process flows 400 may take Yes branch 412 to block 414, which represents replacing the call located in block 404. Assuming a SIP implementation, block 414 may include, for example, executing a SIP-compliant invite-with-replace command.

Returning to block 410, if block 404 did not locate a call corresponding to the GUID, then most likely, an error has occurred. In this case, the process flows 400 may take No branch 416 to block 418 to report an error or other suitable condition.

Having described the above process flows 400, several observations are noted. In contrast to previous techniques that involved searching records for potentially all active calls when locating the call to be replaced, the tools described herein locate and retrieve the record with one query, which specifies the GUID as an index or search key. These previous techniques may include searching each active call, and comparing the call ID (e.g., 208), From tag (e.g., 210), and To tag (e.g., 212) to a set of input call parameters to locate the call to be replaced. Thus, the search effort drops from a linear search having complexity level O(3n) to a single search having complexity level O(1).

### Conclusion

Although the systems and methods have been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain data and process flow diagrams described and illustrated herein, it is noted that the processes and sub-processes depicted therein may be performed in orders other than those illustrated without departing from the spirit and scope of the description herein. Also, while these data and process flows are described in connection with certain components herein, it is noted that these data and process flows could be performed with other components without departing from the spirit and scope of the description herein.

1. At least one machine-readable storage medium comprising machine-readable instructions that, when executed by the machine, cause the machine to perform a method comprising:
receiving at least one indication of at least one incoming call; and
populating at least a field in a contact header associated with the incoming call, wherein the field is for containing a globally unique identifier (GUID) associated with the incoming call.

2. The machine-readable storage medium of claim 1, further comprising instructions for instantiating the contact header.

3. The machine-readable storage medium of claim 1, further comprising instructions for instantiating the contact header, wherein the contact header includes a call identifier field, an originator field indicating an originator of the call, and a recipient field indicating a recipient of the call.

4. The machine-readable storage medium of claim 3, further comprising instructions for populating the call identifier field, the originator field, or the recipient field.

5. The machine-readable storage medium of claim 1, further comprising instructions for receiving the GUID.

6. The machine-readable storage medium of claim 1, further comprising instructions for generating the GUID.

7. A server comprising at least the machine-readable storage medium of claim 1.

8. At least one machine-readable storage medium comprising machine-readable instructions that, when executed by the machine, cause the machine to perform a method comprising:
receiving at least one request to replace at least one call within a plurality of active calls handled by a server; and
searching for the call using a globally unique identifier (GUID).

9. The machine-readable storage medium of claim 8, further comprising instructions for identifying the GUID.

10. The machine-readable storage medium of claim 8, wherein the instructions for searching for the call include instructions for searching for a contact header structure that includes the GUID.

11. The machine-readable storage medium of claim 8, further comprising instructions for replacing the call, wherein the call is associated with the GUID.

12. The machine-readable storage medium of claim 11, wherein the instructions for replacing the call include instructions that are compliant with the Session Initiation Protocol (SIP).

13. The machine-readable storage medium of claim 8, wherein the instructions for receiving the request include instructions that are compliant with the Session Initiation Protocol (SIP).

14. The machine-readable storage medium of claim 8, wherein the instructions for searching for the call include instructions for performing a single query to locate the call, using the GUID.

15. The machine-readable storage medium of claim 8, wherein the instructions for searching for the call include instructions for querying to locate the call, using the GUID as a search key.

16. A server comprising at least the machine-readable storage medium of claim 8.

17. The machine-readable storage medium of claim 8, further comprising instructions for receiving at least one indication of at least one incoming call.

18. The machine-readable storage medium of claim 17, further comprising instructions for populating at least a field in a contact header associated with the incoming call, wherein the field is for containing the GUID associated with the incoming call.

19. The machine-readable storage medium of claim 18, further comprising instructions for instantiating the contact header.

20. The machine-readable storage medium of claim 18, further comprising instructions for instantiating the contact header, wherein the contact header includes a call identifier field, an originator field indicating an originator of the call, and a recipient field indicating a recipient of the call.
